(19) United States
(12) Patent Application Publication
(10) Pub. No.: US 2021/0138976 A1
(43) Pub. Date: May 13, 2021

(54) BODYWORK PART COMPRISING AN OVERMOLDED INSERT MADE FROM AMORPHOUS POLYOLEFIN

(71) Applicant: COMPAGNIE PLASTIC OMNIUM, Lyon (FR)

(72) Inventors: Jean-François PRAT, Genas (FR); Laura MOISAN, Sathonay-Camp (FR)

(73) Assignee: COMPAGNIE PLASTIC OMNIUM, Lyon (FR)

(21) Appl. No.: 17/045,848

(22) PCT Filed: Apr. 10, 2019
(86) PCT No.: PCT/EP2019/059158

§ 371 Date: Oct. 7, 2020

(30) Foreign Application Priority Data
Apr. 10, 2018 (FR) 1853141

(51) Int. Cl. B60R 13/04; B32B 3/30; B32B 27/08; B32B 27/32; B32B 27/20; B29C 45/14

(52) U.S. Cl. CPC B60R 13/04; B32B 3/30; B32B 27/08; B32B 27/32; B32B 27/20; B29C 45/14; B29L 2031/3005; B32B 2307/414; B29K 2995/0026; B29K 2995/0029; B32B 2262/101; B32B 2605/006; B32B 2307/412

(57) ABSTRACT

The invention concerns a bodywork part for a motor vehicle comprising at least one transparent or translucent overmolded insert), the insert being produced from a material made from amorphous polyolefin.

### CROSS-REFERENCE TO RELATED APPLICATIONS

This application claims priority under 35 U.S.C. § 371 to the International Application No. PCT/EP2019/059158, filed Apr. 10, 2019, and to the French Application No. 1853141, filed Apr. 10, 2018, now pending, the contents of which are hereby incorporated by reference.

The invention relates to the field of the automotive industry, and more particularly to a motor vehicle bodywork part comprising a transparent or translucent element.

An element is described as transparent when it allows light to pass through in the visible domain. An element having a transmittance of about 90% is considered to be transparent. An element is qualified as translucent when it allows light to pass through in the visible domain, but without making it possible to clearly distinguish the objects. An element having a transmittance of about 60% is considered to be translucent.

The transmittance of a material is the fraction of the luminous flux passing through it. Thus, the transmittance represents the ratio of the light intensity transmitted by the material to the incident light intensity.

Elements are known that are attached to a bodywork part having the particular aim of enhancing a line or emphasizing a shape in order to reinforce the image that the manufacturer wishes to associate with its vehicle model.

For example, the chrome strips running along the side of the vehicle, the rocker panels, the brand logo, the door handle trims, the mirror caps are these style elements whose design is subject to special care by the designers of the vehicle.

In order to enhance the effect produced by these bodywork elements, it has been proposed to place a light source behind a surface of the bodywork element formed from a transparent material.

All of the bodywork parts visible from the outside of the vehicle, such as an opening, a bumper, a grille, can also be considered to be bodywork elements falling within the scope of the invention.

Bodywork parts are known that result from molding plastic material, and on which a transparent element is attached in a housing provided for this purpose.

These transparent elements have the drawback of having to be perfectly adapted to the housing present in the bodywork part. In addition, the assembly of such optical elements on bodywork parts has the drawback of revealing assembly clearances and significant projections, which are incompatible with the visual quality required for a motor vehicle. Finally, such attached elements create complexity in the management of the seal.

To avoid these problems of an element attached to a part, bodywork parts are also known that result from the molding of plastic material, overmolding one or more inserts. These inserts are preformed parts incorporated into, and/or integral with, said molded part that generally serve to reinforce said molded part and/or for the subsequent fixing of mechanical elements.

Furthermore, the transparent material used to manufacture a transparent element must allow optimum diffusion of the light passing through it, while having a fairly large capacity to withstand impacts. The transparent materials used in automobiles are PMMA (headlight inserts, excluding impact zones) and polycarbonate (PC).

However, these materials are not compatible with polypropylene (PP). Yet the bodywork parts resulting from molding are mainly manufactured with a material based on polypropylene (PP). As a result, there is not sufficient adhesion to create an insert that is not attached with fixing means with this material in an outer part made from polypropylene (PP).

As for the various polypropylene-based plastics, they are opaque, and therefore cannot be used to manufacture a transparent element.

Although it is possible to add additives in order to improve their transparency, they are then unable to meet the specifications, in particular with regard to impact resistance and for thermal resistance, such as the coefficient of expansion. And conversely, if they are modified by the addition of elastomers, filler, fibers or dyes, their optical properties are modified and their transmittance decreases.

Furthermore, unfilled polypropylene elements have different thermal properties from those of the polypropylenes used in bodywork parts. This causes design errors, stresses at the interfaces, causing variable geometries and separations, inter alia.

The object of the invention is to address these drawbacks by using a transparent or translucent element made from amorphous polyolefin, such as COC or COP.

Thus, the object of the invention relates to a motor vehicle bodywork part comprising at least one overmolded insert made from amorphous polyolefin.

Using amorphous polyolefin makes it possible to obtain very good chemical adhesion to the bodywork part made from polypropylene, and therefore allows the insertion of a transparent or translucent element by overmolding. In addition, such adhesion allows the transmission of forces from the overmolded transparent element to the main body of the polypropylene part.

Indeed, an insert alone does not have satisfactory impact resistance, and an insert attached to a part is also easily damaged during an impact. The advantage of using an overmolded insert is, surprisingly, that the overmolding makes it possible to transmit the energy of an impact on the insert into the main body of the polypropylene part. It is the overmolding and the good adhesion at the interface between the polyolefin insert and the rest of the polypropylene part that makes it possible to obtain such a mechanical effect.

In addition, the amorphous polyolefin elements are very strong and can be bent (naturally deformable) without detriment to the aesthetics or the geometry of the part. This property comes from the amorphous nature of the polyolefin.

Lastly, the thermal properties (thermal contraction, expansion) of the amorphous polyolefin elements are compatible with those of polypropylene, in particular of filled polypropylene as used in the automotive field, which makes it possible to avoid dimensional problems during the baking steps of the painting line for example.

Thus, an amorphous polyolefin element is painted in the same way as a polypropylene part because its chemical compatibility with the components of the paint is equivalent. When the transparent insert is made from polycarbonate (PC) or PMMA, it is not possible to varnish or paint it with the same products as polypropylene (PP), because the adhesion of these products would not be the same on the polypropylene (PP) parts and on the PC or PMMA parts.

The bodywork part may also include one or more of the following features, taken alone or in combination:
the amorphous polyolefin has a transmittance substantially greater than 50%;
the part comprises a main body made of a plastic material, said insert being partially overmolded in the main body;
the insert comprises a surface intended to be visible from outside the vehicle and an opposite surface, at least one of said surfaces not being covered by the plastic material of the main body, preferably both surfaces not being fully covered by the plastic material of the main body.
the main body is made from a plastic material with a base of polypropylene;
at least one of said surfaces of the insert is grained;
the insert is made from a cyclic polyolefin-based material;
the insert is made from a material with a base of at least one of the following materials: cyclo-olefin-copolymers and cyclo-olefin-polymers;
the insert is made from a material with a base of transparent or translucent amorphous polyolefin comprising at least one of the following additives: an elastomeric filler, crushed/short glass fibers, a dye;
the part forms a front or rear bumper of a motor vehicle, a tailgate, a roof, a door or even a fender.

The invention also relates to a motor vehicle comprising at least one bodywork part according to the invention.

The invention also relates to a first method of manufacturing a part according to the invention, in which:
a transparent or translucent insert is produced by means of an amorphous polyolefin molding method in a first mold;
the insert is placed in a second mold;
a polypropylene-based plastic material is injected into the second mold, in order to overmold the insert, while protecting the two surfaces of the insert intended to allow light to pass.

The invention also relates to a second method of manufacturing a part according to the invention, in which:
a transparent or translucent insert is produced by means of an amorphous polyolefin injection molding method in a mold comprising a molding cavity of the insert delimited by movable wedges; then, after movement of the wedges;
a polypropylene-based plastic is injected into the mold, comprising a molding cavity of a main body of the part, in order to overmold the insert, while protecting the two surfaces of the insert that are intended to allow light to pass.

The invention will be better understood upon reading the appended FIG. 1, which is provided by way of example and is in no way limiting.

FIG. 1 illustrates an example of a motor vehicle according to the invention, comprising a set of bodywork parts according to the invention, provided with a transparent or translucent insert.

According to the examples of FIG. 1, the bodywork part 10 can be a front or rear bumper (not visible in the FIGUE), a tailgate, a roof, a door or even a motor vehicle fender 40.

The bodywork part 10 comprises a zone intended to allow the light coming from a light source placed behind said zone to pass, at least partially.

To that end, the part 10 comprises a transparent or translucent element at this zone.

The transparent or translucent element is overmolded in the part 10, and thus constitutes an overmolded insert 20.

This overmolded insert 20 is transparent or translucent, and it is made of a plastic material with a base of amorphous polyolefin.

An amorphous polyolefin is a chemical compound whose atoms do not respect any order at medium and long distance, which distinguishes it from crystalline compounds. The amorphous character gives the polyolefin a property of transparency.

Preferably, an amorphous polyolefin is used having a transmittance chosen based on the desired use. Thus, it is possible to use an amorphous polyolefin having a transmittance:
substantially greater than 50%, for a diffusion of light toward the outside of the vehicle while making it impossible to see toward the inside of the vehicle;
substantially greater than 60%, for a diffusion of light toward the outside of the vehicle which is less diffuse;
substantially greater than 90% in order to produce an overmolded insert through which it is desired to see toward the inside of the vehicle.

The insert 20 comprises a surface intended to be visible from the outside of the vehicle (surface facing the outside of the vehicle) and an opposite surface (surface facing the inside of the vehicle). The insert 20 is partially overmolded so that at least one of the two surfaces (preferably the surface intended to be visible) is not entirely covered by the overmolding material (polypropylene of the main body 30), in order to allow at least part of the light to pass.

However, the opposite surface (surface facing the inside of the vehicle) may be covered directly or indirectly by the material of the main body 30.

Indeed, it is for example possible to overmold the insert 20, by interposing a light guide between this surface and the material of the main body 30. Thus, the light transmitted to the insert 20 by the guide could pass through the insert 20 to the outside of the vehicle. It is also possible to overmold the insert 20, by positioning a light guide on its edge. That is to say, the light would be transmitted to the insert 20 not by its surface facing the inside of the vehicle, but by one side (substantially perpendicular to the two surfaces of the insert 20). Thus, the light transmitted to the insert 20 by the guide could pass through the insert 20 toward the outside of the vehicle, and the opposite surface (surface facing the inside of the vehicle) could be in direct contact with the overmolding material (polypropylene of the main body 30).

According to one embodiment, at least one of these surfaces (the surface facing the inside of the vehicle and/or the surface facing the outside of the vehicle) undergoes a treatment, such as graining, in order to modify the transparency or the translucency of the insert (and not of the amorphous polyolefin). In fact, it is also possible to use an amorphous polyolefin having a transmittance greater than 90%, then to emboss a surface of the insert 20 in order to conceal the light sources or the hot spots from the outside of the vehicle.

The part 10 thus comprises a main body 30, the insert 20 being overmolded in the main body 30.

According to a particular embodiment, the main body 30 is made from a plastic material with a base of polypropylene (PP). According to one example, this material is opaque and/or black in color.

The amorphous polyolefin-based plastic material makes it possible to meet the need for transparency or translucency, in order to at least partially allow the light coming from the light source to pass, and the need for mechanical strength, substantially equivalent to that of the main body 30.

According to one embodiment, the insert 20 is made from a material with a base of cyclic polyolefin.

Preferably, the insert 20 is made from a material with a base of at least one of the following materials: cyclo-olefin-copolymers (COC) and cyclo-olefin-polymers (COP).

It is also possible to add additives to the material of the insert 20. For example, at least one of the following additives can be added:
an elastomeric filler in order to increase the plasticity of the insert 20, and thus to be able to deform it more easily, to improve its mechanical properties on impact and also its thermal properties;
crushed or short glass fibers, in order to increase the mechanical strength of the insert 20;
a dye, in order to improve the aesthetics of the part 10.

As illustrated in FIG. 1, the invention also relates to a motor vehicle 40 comprising at least one bodywork part 10 according to the invention.

The invention also relates to a first method of manufacturing a part 10 according to the invention.

The first method is a molding method comprising the following steps:
the insert 20 is produced by means of an amorphous polyolefin molding method in a first mold;
the insert 20 is placed in a second mold, by means of a robot for example;
a polypropylene-based plastic material is injected into the second mold, in order to overmold the insert 20, while protecting the two surfaces intended to allow light to pass (in order to prevent the polypropylene-based plastic material from covering these surfaces).

The invention also relates to a second method of manufacturing a part 10 according to the invention.

The second method is a bi-injection molding method in a single mold, and it comprises the following steps:
the insert 20 is produced by means of an amorphous polyolefin injection molding method in the mold comprising a molding cavity for the insert 20 delimited by movable wedges;
then, after movement of the wedges,
a polypropylene-based plastic material is injected into the same mold, comprising a molding cavity of the main body 30, in order to overmold the insert 20, while protecting the two surfaces intended to allow light to pass (in order to prevent polypropylene-based plastic from covering these surfaces).

Alternatively for this second method, a rotary mold can be used to replace the movable wedges.

### NOMENCLATURE

10: motor vehicle bodywork part 40
20: transparent and overmolded insert in part 10
30: main body of part 10 including insert 20
40: motor vehicle

1. A motor vehicle bodywork part, characterized in that it comprises at least one overmolded insert with a base of amorphous polyolefin.

2. The part according to claim 1, wherein the amorphous polyolefin has a transmittance substantially greater than 50%.

3. The part according to claim 1, comprising a main body made from a plastic material, said insert being partially overmolded in the main body.

4. The part according to claim 1, in which the insert comprises a surface intended to be visible from outside the vehicle and an opposite surface, at least one of said surfaces not being entirely covered by the plastic material of the main body, preferably both surfaces not being fully covered by the plastic material of the main body.

5. The part according to either of claim 4, in which the main body is made from a plastic material with a base of polypropylene.

6. The part according to either of claim 5, in which at least one of said surfaces of the insert is grained.

7. The part according to claim 1, in which the insert is made from a material with a base of cyclic polyolefin.

8. The part according to claim 1, in which the insert is made from a material with a base of at least one of the following materials: cyclo-olefin-copolymers (COC) and cyclo-olefin-polymers (COP).

9. The part according claim 1, in which the insert is made from a material with a base of transparent or translucent amorphous polyolefin comprising at least one of the following additives: an elastomeric filler, crushed/short glass fibers, a dye.

10. The part according to claim 1, forming a front or rear bumper of a motor vehicle, a tailgate, a roof, a door or even a fender.

11. A motor vehicle comprising at least one bodywork part according to claim 1.

12. A method of manufacturing a part according to claim 1, in which:
a transparent or translucent insert is produced by means of an amorphous polyolefin molding method in a first mold;
the insert is placed in a second mold;
a polypropylene-based plastic material is injected into the second mold, in order to overmold the insert, while protecting the two surfaces of the insert intended to allow light to pass.

13. The method of manufacturing a part according to claim 10, in which:
a transparent or translucent insert is produced by means of an amorphous polyolefin injection molding method in a mold comprising a molding cavity of the insert delimited by movable wedges; then, after movement of the wedges;
a polypropylene-based plastic is injected into the mold, comprising a molding cavity of a main body of the part, in order to overmold the insert, while protecting the two surfaces of the insert that are intended to allow light to pass.
